(19) United States
(12) Patent Application Publication
(10) Pub. No.: US 2012/0174604 A1
(43) Pub. Date: Jul. 12, 2012

(54) REFRIGERATION SYSTEM WITH A DISTRIBUTOR HAVING A FLOW CONTROL MECHANISM AND A METHOD FOR CONTROLLING SUCH A SYSTEM

(75) Inventors: Ole Thøgersen, Nyborg (DK); Allan Dyrmose, Bogense (DK)

(73) Assignee: THERMO KING CORPORATION, Minneapolis, MN (US)

(21) Appl. No.: 13/345,574

(22) Filed: Jan. 6, 2012

Related U.S. Application Data
(60) Provisional application No. 61/430,656, filed on Jan. 7, 2011.

(51) Int. Cl. F25B 1/00; G05D 23/32

(52) U.S. Cl. 62/115; 62/498; 62/157

(57) ABSTRACT

A method of controlling a refrigeration system with a closed circuit for circulating a refrigerant wherein the closed circuit has a compressor for compressing the refrigerant, a condenser for receiving and condensing at least part of the compressed refrigerant, an evaporator for receiving and evaporating the condensed refrigerant, and a return conduit for returning the refrigerant from the evaporator to the compressor. The evaporator has several evaporator sections with corresponding conduits that may be individually controlled so as to obtain individual refrigeration effects of corresponding individual evaporator sections.

### PRIORITY CLAIM

This application hereby claims priority to U.S. Patent Application No. 61/430,656, filed on Jan. 7, 2011.

### FIELD

This invention relates to climate control in cargo containers and to methods and devices for controlling the climate in cargo containers. In particular the invention relates to an evaporator with a distributor valve for refrigeration systems for use in cargo containers and methods for operating such systems.

### BACKGROUND

Transporting and storing temperature sensitive cargo over long periods of time requires a controlled climate in the space where the cargo is loaded. Climate control includes controlling the temperature of the cargo within a certain acceptable range. Controlling the temperature includes bringing the temperature of the cargo into an acceptable range (by refrigerating or by heating) and maintaining the temperature within that range. Climate control may also include controlling other parameters such as humidity and composition of the atmosphere.

Refrigeration is the process of removing heat from an enclosed space, or from a substance, and moving the heat to a place where it is unobjectionable. The primary purpose of refrigeration is lowering the temperature of the enclosed space or substance and then maintaining that lower temperature.

One commonly used refrigeration technique is the vapor-compression cycle. The vapor-compression cycle is used in most household refrigerators as well as in many large commercial and industrial refrigeration systems.

A refrigerated container, which also referred to as a reefer, is a shipping container used in intermodal freight transport, including rail, ship and truck, where temperature sensitive cargo is refrigerated (chilled or frozen). A refrigerated container will usually have an integral refrigeration system.

The reliability of the refrigeration system is of paramount importance. The temperature of temperature sensitive cargo should be kept within predefined limits. Some cargo must be maintained frozen, and the temperature of any part of the frozen cargo must be kept below a predefined freezing temperature which depends on the cargo, e.g. below −18 degrees C. or lower, while commodities such as fresh fruit and vegetables should be kept chilled, but not frozen, to stay fresh. For chilled fruit and vegetables there is a lowest acceptable temperature below which the commodity will begin degrading and loose its freshness. Such temperature is individual for each kind of fruit.

During operation of a refrigeration system water vapor will condensate on the evaporator and form a layer of ice that will degrade the efficiency of the evaporator and thereby of the refrigeration system. The ice is removed by running a defrosting cycle. Traditionally, defrosting cycles are initiated according to a predetermined schedule at time intervals which may depend on the nature of the cargo and the time since its loading into the container. When being loaded into the container the cargo may have a temperature that is higher than the temperature it is desired to maintain in the container, and refrigeration is used to lower the temperature. The initial phase of refrigeration after the cargo has been loaded into the container and the cargo temperature is lowered is referred to as pull-down. During pull-down the temperature difference between return air from the container and the supply air to the container is relatively high, and much water vapor will condensate on the evaporator, and frequent defrost of the evaporator is therefore necessary. This is the case when the cargo is commodities such as fresh fruit or vegetables. When the temperature of the cargo has reached the set point temperature the evaporation will be relatively low and the intervals between defrosting can then be correspondingly longer. Depending on the cargo defrosting traditionally follows a predefined schedule with intervals which have been determined by experience.

Defrosting is usually done by inactivating the compressor of the refrigeration system and activating a heater associated with the evaporator whereby the ice on the evaporator melts. After a period of defrosting the heater is inactivated and the compressor is again activated.

Humidity control usually requires dehumidification of the air but may potentially also require injection of water vapor into the container. When dehumidification is desired the evaporator of the refrigeration system will normally be used for that purpose, and water vapor in the air will condensate on the on the evaporator and the condensed water vapor is thereby removed from the air. When sufficient dehumidification cannot be achieved by running the refrigeration system in its primary mode for refrigerating the air, the evaporator, or a portion thereof, can be operated at a higher refrigeration power and consequently at a lower temperature, whereby more water vapor is caused to condensate on the evaporator, and higher dehumidification is achieved. The higher refrigeration power that is applied to the evaporator will also cause the supply air from the refrigeration system to the cargo to be cooler. For some commodities such as fresh fruit the temperature of the supply air should not be lower than a predefined set point temperature, and in order to avoid that the temperature of the supply air becomes lower than the set point temperature, a heater will usually be activated to compensate for the higher refrigeration power. Such heater will usually be associated with the evaporator and arranged close to where the heating energy is needed and it may also be used for defrosting. The energy supplied to the heater is intended to compensate for the extra refrigeration energy used for the forced dehumidification. Traditionally, such heater is an electric heating element that converts electrical energy into thermal energy that is dissipated in the cargo room of the container, and the dissipated thermal energy from the heater must be removed by the refrigeration system.

Evaporators used in refrigeration systems for controlling the climate in cargo containers usually have a plurality of evaporator sections which are supplied individually with condensed refrigerant through respective injection tubes. Condensed refrigerant is supplied to a distributor of the type where a single inlet expands like a funnel and connects to a plurality of outlets. Each outlet from the distributor is connected to an injection tube of the evaporator and thus feeds the corresponding evaporator section. This arrangement aims at ensuring a uniform distribution of the refrigerant throughout the evaporator and thereby to obtain a more uniform refrigeration effect provided by the individual evaporator sections.

### SUMMARY

The invention provides a refrigeration system that allows individual control of the sections of an evaporator of the system to obtain individual refrigeration effects of individual evaporator sections. This is particularly useful for dehumidification. The refrigeration system also allows controlling an evaporator of the system to more efficiently perform defrosting of the evaporator. The invention provides a refrigeration system where the externally supplied energy in forced dehumidification mode is reduced compared to traditional systems.

The system of the invention, where sections of the evaporator may be controlled individually, e.g. turned on or off, to allow compensating for the extra refrigeration energy used for the forced dehumidification. This is done by operating one or more sections of the evaporator at elevated refrigeration power to achieve dehumidification and having other evaporator sections turned off.

When a first subset comprising one or more, but not all, evaporator sections is operated at elevated refrigeration power for dehumidification, humidity will condensate on those evaporator sections and possibly form a layer of ice. Traditionally this requires running a defrosting cycle of the refrigeration system which involves inactivation of the refrigeration system for a period and heating of the evaporator for melting the ice. The invention provides the possibility of operating the refrigeration system to shift from the first subset of evaporator sections to a second subset of evaporator sections whereby the ice on the first subset of evaporator sections will be allowed to melt, while refrigeration and dehumidification are continued using the second subset of evaporator sections.

When the air in the refrigerated space is very humid or the cargo generates large amounts of humidity, dehumidification requires correspondingly high refrigeration power which may cause the temperature of the air to become undesirably low. Traditionally this is avoided by activating e.g. an electric heater to heat the air. In embodiments the system of the invention uses heat that is already generated by the system itself, namely by the compressor, to compensate for the extra refrigeration energy used for the forced dehumidification. This is done by operating a section of the evaporator at elevated refrigeration power to achieve the desired dehumidification and by selectively conducting a portion of the compressed, i.e. hot, refrigerant from the compressor, i.e. bypassing the condenser, to another section of the evaporator. Hereby a separate heating element is no longer needed and externally supplied energy for heating is also no longer needed. The thermal energy that is needed to compensate for the extra refrigeration power that used for the forced dehumidification is taken from the refrigerant that leaves the compressor. When the compressed refrigerant leaves the compressor it is “hot”, or at an elevated temperature relative to the temperature of the refrigerant that enters the compressor and also relative to the refrigerant that leaves the condenser. Traditionally all the hot refrigerant from the compressor is condensed and cooled in a condenser that may be fan assisted or in a water-cooled heat exchanger. In a refrigeration system of the invention the portion of the hot compressed refrigerant that is conducted to the evaporator is not conducted to the condenser, and the need for power supply to the condenser is thus reduced.

Throughout this document the terms “comprising” or “comprises” do not exclude other possible elements or steps. Also, the mentioning of references such as “a” or “an” etc. should not be construed as excluding a plurality.

### BRIEF DESCRIPTION OF THE DRAWINGS

The system and method according to the invention will now be described in more detail with regard to the accompanying figures. The figures show one way of implementing the present invention and is not to be construed as being limiting to other possible embodiments falling within the scope of the attached claim set

FIG. 1 illustrates one refrigeration system controllable by a method of the invention;

FIG. 2 illustrates a distributor with a flow control mechanism and a section of an evaporator of a refrigeration system, such as the one shown in FIG. 1; and

FIG. 3 shows, in a partly see through, perspective view of a distributor with a flow control mechanism.

### DETAILED DESCRIPTION

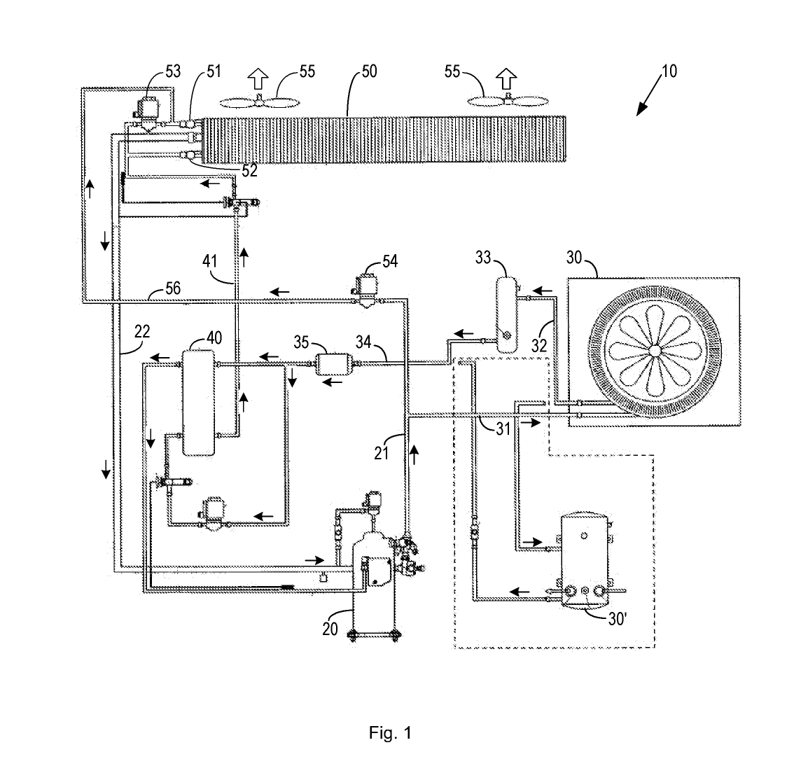

In FIG. 1 is shown a refrigeration system 10 with a compressor 20 which in operation compresses a refrigerant used in the refrigeration system. The compressor 20 may be a scroll compressor but other types of compressor may also be used. Compressed and hot refrigerant is conducted from the compressor 20 through conduits 21 and 31 to a condenser 30 where heat energy is removed from the refrigerant. The shown condenser 30 is fan assisted, and condensed cold refrigerant leaves the condenser through a conduit 32 and enters a receiver tank 33. If supplementary condenser effect is needed an optional water-cooled condenser 30′ (shown in a dash-line frame) may be applied. From the receiver tank 33 or optionally the water-cooled condenser 30′ the condensed refrigerant is conducted through a conduit 34 through a drier oil filter 35 to an economizer heat exchanger 40 and through a conduit 41 to an evaporator 50. Fans 55 circulate the air through the evaporator and through a cargo in a container.

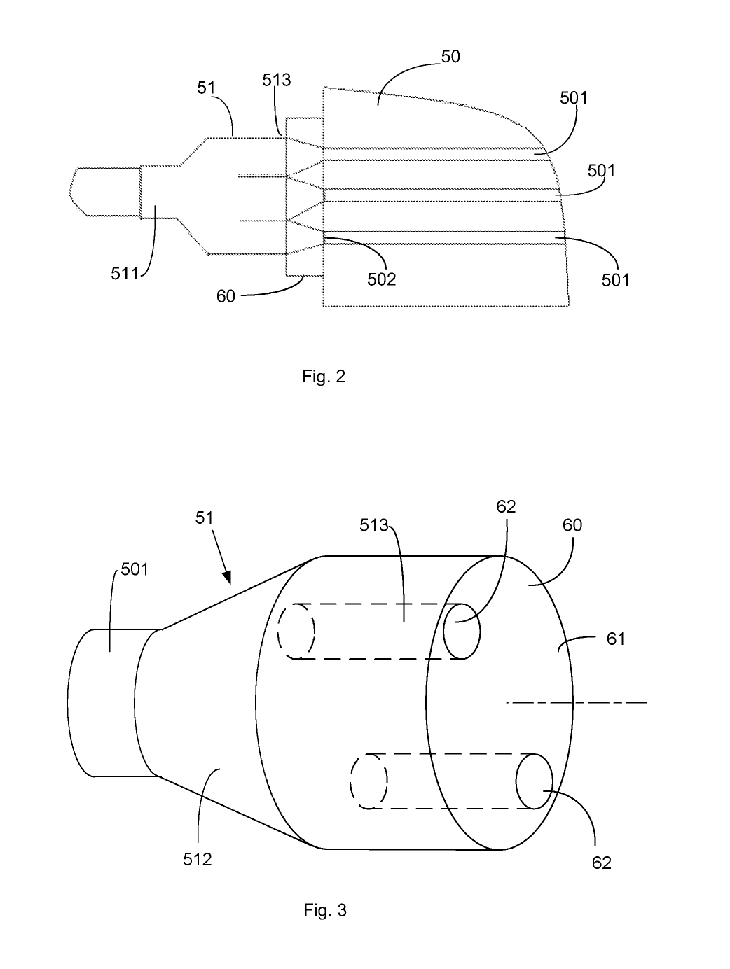

In FIG. 2 is schematically shown details of the refrigeration system in FIG. 1. FIG. 2 shows a distributor 51 connected at one end to a refrigerant supply conduit to receive compressed refrigerant, and at the other end to an evaporator 50. Only a small section of the evaporator is shown in the figure and partly see-through.

The evaporator 50 has several injection tubes 502, leading to individual conduits 501 of corresponding evaporator sections for conducting refrigerant through the evaporator. Each injection tube 502 has an individual inlet connected to an individual outlet 513 of the corresponding distributor 51, 52. Typically the distributor 51, 52 will have eight symmetrically disposed injection tubes 502 connected to an evaporator. In the system 10 shown in FIG. 1 there are two distributors 51 and 52.

The distributors 51, 52 each has an inlet 511 connected to a conduit for supplying condensed refrigerant to the evaporator 50, an expanding funnel part 512, and a plurality of outlets 513. Each of the distributor outlets 513 is connected to an individual injection tube 502, and thus to the conduits 501 of the evaporator. The funnel part 512 distributes the single flow of refrigerant from the distributor inlet 511 to the plurality of distributor outlets 513, and thus to the individual injection tubes 502.

A flow control mechanism 60 is provided in connection with the distributor 51. The flow control mechanism 60 is preferably an integrated part of the distributor 51, 52, or it may be provided as a separate part connected between the distributor 51, 52 and the evaporator 50. The flow control mechanism is adapted to controlling flow of refrigerant through individual distributor outlets 513 and thus into individual injection tubes 502 at individual times and for individual periods of time.

The control mechanism 60 may be of a type comprising a disc 61 with one or more passages 62, placed on the disc 61 in locations corresponding to the outlets 513 of the distributor 51, 52, e.g. as shown in FIG. 3. In the FIG. 3 embodiment the flow control mechanism 60 is integrated with the distributor 51, and is shown with two passages 62. In other embodiments the disc may have one passage 62, or it may have more than three. The disc 61 is arranged rotatably around an axis of the distributor 51, and at an end surface of the distributor 51. The disc 61 may be driven by e.g. a stepping motor (not shown) to move the passage/passages 62 to open partially or fully the flow through an outlet 513 of the distributor and into the injection tubes 501 of the evaporator 50. A sealing (not shown) is provided so that the connection is tight with respect to the refrigerant. In FIG. 3, the passages 62 are aligned fully with the outlets 513 so that a maximum flow may be provided. Further, in FIG. 3 two open outlets 513 are shown in dotted line. The remaining, closed, outlets are not shown.

In operation the flow control mechanism 60 alternately opens one or more outlets 513 and closes other of the outlets 513 from the distributor 51, 52. The refrigerant will then flow in the closed circuit from the compressor 20 through conduits 21 and 31, condenser 30, receiver tank 33, conduit 34, drier oil filter 35, heat exchanger 40, conduit 41, first and/or second distributors 51, 52, and alternate sections or parts of the evaporator 50 and return conduit 22 back to the compressor 20. Thereby sections, defined by the elected conduits 501, of the evaporator 50 may be turned on or off allowing enhanced control of the dehumidification of the air circulated through the evaporator 50, and thereby of e.g. a container in which the refrigeration system is located.

In a method according to the invention the flow control mechanism 60 allows flow of refrigerant to one or more conduits 501 of the evaporator 50 in intervals of time such that the elected conduits 501 are refrigerated more than others or “supercooled”, thereby enhancing dehumidification of the air passing those conduits 501. In order to maintain a constant temperature in a cargo space to which the refrigeration system is connected, the control mechanism 60 allows a reduced flow of refrigerant to other than the elected supercooled conduits 501 of the evaporator 50 in the intervals of time. Thereby the collected mass of gas (air) passing the evaporator 50 keeps a constant temperature, while sections or parts evaporator 50 i.e. individual, elected conduits of the evaporator are either supercooling or run at normal or at reduced cooling.

In a further method according to the invention the flow control mechanism 60 allows flow of refrigerant to one or more conduits 501 of the evaporator 50 in intervals of time such that the elected conduits 501 are cooling normally or supercooling, while other of the conduits 501 are turned off for intervals of time of sufficient length to allow defrosting of the conduits 501 being turned off.

In further embodiments, the refrigeration system 10, shown in FIG. 1 has a first distributor 51 and a second distributor 52 each of which is connected to receive cold condensed refrigerant through the conduit 41.

The first distributor 51 feeds refrigerant to conduits 501 of a first part of the evaporator 50, and the second distributor 52 feeds refrigerant to conduits 501 of a second part of the evaporator 50.

On its upstream side the first distributor 51 is connected to a first controllable valve 53. A second controllable valve 54 is connected to the conduit 21 that conducts hot compressed refrigerant from the compressor 20, and a conduit 56 connects the outlet of the second controllable valve 54 with the inlet of the first distributor 51.

In a first mode of operation the first controllable valve 53 is open and the second controllable valve 54 is closed. The refrigerant will then flow in the closed circuit from the compressor 20 through conduits 21 and 31, condenser 30, receiver tank 33, conduit 34, drier oil filter 35, heat exchanger 40, conduit 41, first and second distributors 51, 52, evaporator 50 and return conduit 22 back to the compressor 20. The first mode of operation is thus a refrigeration mode where both the first and the second distributor 51, 52 receive cold refrigerant which is fed into both the first and the second parts of the evaporator.

If the cargo is a commodity such as fresh fruit and supplemental dehumidification of the circulated air is desired, the refrigeration system will be switched to a second mode of operation in which the first controllable valve 53 is closed, and the first distributor 51 will thus no longer be connected to the conduit 41, and it will no longer receive cold refrigerant as in the first mode of operation. In the second mode of operation the second controllable valve 54 can be opened so that hot refrigerant from the compressor will be conducted through conduit 21, the second controllable valve 54 and conduit 55 to the inlet of the first distributor 51 and into a the corresponding first part of the evaporator 50.

In the second mode of operation the second distributor 52 and the corresponding second part of the evaporator will still receive cold refrigerant like in the first mode of operation described above. The second part of the evaporator can be operated at a refrigeration power level where the desired dehumidification is achieved, and in case the air would thereby be refrigerated to an unacceptable low temperature below the set point temperature the second controllable valve 54 will be opened to conduct hot refrigerant to the first part of the evaporator whereby the air that is drawn through the evaporator by means of the fans 55 will be heated to compensate for the excessive refrigeration in the second part of the evaporator, so that the air that is drawn through the evaporator and supplied to the cargo has a desired temperature.

The invention may also be used for defrosting when ice has accumulated on the evaporator. The supply of cold refrigerant to the evaporator will then be interrupted and hot refrigerant from the compressor will be supplied to the evaporator.

The system may further be controlled using a combination of the flow control mechanism 60 and the switching of flow or the passage of hot refrigerant using the first and second controllable valves 53 and 54 as described above.

A controller (not shown) controls the operation of each of the components of the refrigeration system. The refrigeration system may include other components than those shown and those mentioned above, and the above description only describes components whose function is relevant for understanding the invention.

What is claimed is:

1. A method of operating a refrigeration system comprising:
compressing, in a compressor, a refrigerant;
receiving and condensing, in a condenser, at least part of the compressed refrigerant;
passing the condensed refrigerant though a flow control mechanism having a plurality of outlets;
controlling the flow control mechanism to pass condensed refrigerant through selected ones of a plurality of distributor outlets to selectively and simultaneously send the condensed refrigerant to corresponding ones of a plurality of evaporator conduits;
receiving, in the corresponding ones of the plurality of evaporator conduits, the condensed refrigerant; and
returning the refrigerant from the evaporator to the compressor.

2. The method of claim 1 further comprising:
controlling the flow control mechanism to pass condensed refrigerant to a first subset of conduits of the evaporator to obtain a first predetermined refrigeration effect of the first subset of conduits; and
controlling the flow control mechanism to pass condensed refrigerant to a second subset of conduits of the evaporator so as to obtain a second predetermined refrigeration effect of the second subset of conduits so as to dehumidify the air passing the evaporator and to keep a temperature of the air within predetermined limits.

3. The method of claim 1 further comprising:
controlling the flow control mechanism to pass condensed refrigerant to a first subset of conduits of a first evaporator section to obtain a first predetermined refrigeration effect of the first subset of conduits; and
receiving in a second evaporator section, from the compressor and bypassing the condenser, at least a portion of the compressed refrigerant so as to dehumidify the air passing the evaporator and to keep a temperature of the air within predetermined limits.

4. The method of claim 3 further comprising:
controlling the second flow control mechanism to pass refrigerant, from the compressor and bypassing the condenser, to the second subset of conduits of the second evaporator section to obtain a first predetermined heating effect of the second subset of conduits.

5. The method of claim 1 further comprising:
controlling the flow control mechanism for a first period of time to pass condensed refrigerant to a first subset of conduits of a first evaporator section of the evaporator to obtain a predetermined refrigeration effect of the first subset of conduits; and
controlling a second flow control mechanism for a second period of time to pass condensed refrigerant to a second subset of conduits of a second evaporator section of the evaporator to obtain a second predetermined refrigeration effect of the second subset of conduits.

6. The method of claim 1 further comprising:
controlling the flow control mechanism for a first period of time to pass condensed refrigerant to a first subset of conduits of the evaporator to obtain a predetermined refrigeration effect of the first subset of conduits; and
controlling the flow control mechanism for a second period of time, the second period of time not overlapping the first period of time, to pass refrigerant which has bypassed the condenser to a second subset of conduits of the evaporator to defrost the evaporator.

7. The method of claim 6 further comprising:
receiving in a second evaporator section of the evaporator refrigerant to obtain a second predetermined refrigeration effect of the second evaporator section.

8. A refrigeration system comprising:
a compressor configured to compress a refrigerant;
a condenser configured to condense at least a part of the compressed refrigerant;
a flow control mechanism having a plurality of distributor outlets; and
an evaporator having a plurality of conduits configured to receive condensed refrigerant from the plurality of distributor outlets,
wherein the flow control mechanism is adjustable to pass the condensed refrigerant through selected ones of the plurality of the distributor outlets and through corresponding ones of the plurality of conduits.

9. The refrigeration system of claim 8 wherein:
the flow control mechanism is configured for a first period of time to pass the condensed refrigerant to a first subset of conduits of the evaporator to obtain a first predetermined refrigeration effect; and
the flow control mechanism is configured for a second period of time to pass the condensed refrigerant to a second subset of conduits of the evaporator to dehumidify air passing by the evaporator and to maintain a temperature in a space.

10. The refrigeration system of claim 8, wherein the evaporator includes first and second sections, the refrigeration system further comprising:
a controllable valve configured to selectively pass, from the compressor and bypassing the condenser, a portion of the compressed refrigerant to the second section of the evaporator to dehumidify the air passing the evaporator and to maintain a temperature in a space.

11. The refrigeration system of claim 10 further comprising:
a second flow control mechanism configured to pass refrigerant to a subset of conduits of the second evaporator section to obtain a first predetermined heating effect of the subset of conduits of the second evaporator section.

12. The refrigeration system of claim 8 wherein:
the flow control mechanism is configured for a first period of time to pass condensed refrigerant to a first subset of conduits of a first evaporator section of the evaporator to obtain a predetermined refrigeration effect of the first subset of conduits; and
the flow control mechanism is configured for a second period of time to pass condensed refrigerant to a second subset of conduits of a second evaporator section of the evaporator to obtain a second predetermined refrigeration effect of the second subset of conduits.

13. The refrigeration system of claim 8 wherein:
the flow control mechanism is a first flow control mechanism and is configured for a first period of time to pass condensed refrigerant to a first subset of conduits of a first evaporator section of the evaporator to obtain a predetermined refrigeration effect of the first subset of conduits; and
wherein the refrigeration system includes a second flow control mechanism configured for a second period of time to pass refrigerant, from the compressor and having bypassed the condenser, to a second evaporator section of the evaporator to defrost the first evaporator section.

14. The refrigeration system of claim 13 wherein:
the second evaporator section is configured to receive condensed refrigerant to obtain a second predetermined refrigeration effect of the second evaporator section.

15. The refrigeration system of claim 8 further comprising:
a second flow control mechanism having a plurality of distributor outlets, wherein;
the evaporator having a second section including a plurality of conduits configured to receive condensed refrigerant from the plurality of distributor outlets of the second flow control mechanism, and
wherein the second flow control mechanism is adjustable to pass the condensed refrigerant through selected ones of the plurality of the distributor outlets of the second flow control mechanism and through corresponding ones of the plurality of conduits of the second section.

16. The refrigeration system of claim 15 further comprising:
a first valve selectively configurable to allow the condensed refrigerant to pass to the first flow control mechanism and the second flow control mechanism.

17. The refrigeration system of claim 16 further comprising:
a second valve selectively configurable to allow compressed refrigerant, from the compressor and having bypassed the condenser, to pass to the flow control mechanism.

18. The refrigeration system of claim 8, wherein the flow control mechanism is adjustable to pass the condensed refrigerant through selected ones of the plurality of the distributor outlets and through corresponding ones of the plurality of conduits while inhibiting the passage of the condensed refrigerant through the remaining ones of the plurality of the distributor outlets and through the corresponding remaining ones of the plurality of conduits.
